(19) United States
(12) Patent Application Publication
(10) Pub. No.: US 2007/0104578 A1
(43) Pub. Date: May 10, 2007

(54) Radially-sliding wind turbine

(76) Inventor: James William Andrews, Palmer Lake, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/270,706

(22) Filed: Nov. 9, 2005

(51) Int. Cl. B64C 11/28

(52) U.S. Cl. 416/131

(57) ABSTRACT

According to one embodiment, a wind turbine for the generation of wind power is described. The wind turbine includes one or more turbine blades that slide radially through an axis of rotation of the turbine as the turbine rotates. Accordingly, the faces of the one or more turbine blades do not rotate into the wind.

### FIELD OF THE INVENTION

This invention generally relates to wind turbines and wind-powered generators.

### BACKGROUND

Wind machines and windmills have been in use for over a thousand years. The first windmills were used solely to grind grain. In the middle ages, windmills began being used for additional purposes. For example, the Rhine river delta in modern-day Netherlands was drained using wind power through the use of windmills. Wind turbines—machines that harness the energy of the wind to generate electrical energy—were first invented in Denmark in the 19^{th} century. These early electricity-generating wind turbines typically produced electrical energy for pumps and milling machines.

By the early 1900's, windmill use in the United States began to increase. Windmills were mainly used during this time to generate electricity on farms, as electric power grids had not yet reached remote rural areas. These windmills were typically placed atop open lattice towers.

In the 1970s there was a significant increase in the number of people seeking efficient energy-generation systems which were less harmful to the environment than fossil-fuel energy generation systems. Use of “renewable” energies such as solar and wind began to increase. Although large wind turbine use in the United States dates back to the 1930's, it during this later period that the first major use of wind power for utility electricity generation began to occur.

Since that time, wind turbines have grown in size and economic viability, as long distance electric power transmission allows wind turbines the ability to supply electricity to the electric power grid from places as remote as offshore wind farms. One problem with wind power is its economic viability, or lack thereof. Although current wind turbines produce a substantial amount of energy, they currently do so at a cost higher than nonrenewable energy-powered devices. Wind turbines require high sustained winds and taxpayer subsidies to even be able to compete economically with fossil fuel energy generation systems. Given the recent rise in energy prices due to an increased demand and a decreasing supply of fossil-fuels, however, more attention is now being given renewable energies such as wind power.

The high cost per unit of energy produced by wind turbines, particularly “water-wheel style” wind turbines, is due in part to opposing drag placed on turbine blades by the wind as the blade moves around an axis of rotation. Energy is therefore lost when the turbine blade rotates towards the oncoming wind and the wind creates a force on the blade opposing the energy-producing rotational direction. A common goal, therefore, of water-wheel style wind turbines, is to minimize this opposing force, thereby minimizing lost energy.

### SUMMARY OF THE DRAWINGS

FIG. 1 is an isometric view of a radially-sliding wind turbine illustrating horizontal and vertical blade positioning according to one embodiment of the current invention.

FIG. 2 is an isometric view of a radially-sliding wind turbine illustrating radial blade movement according to one embodiment of the current invention.

FIG. 3a is a side view of a radially-sliding wind turbine illustrating horizontal and vertical blade positioning according to one embodiment of the current invention.

FIG. 3b is a side view of a radially-sliding wind turbine illustrating radial blade movement according to one embodiment of the current invention.

FIG. 4 is an isometric view of a radial-directing slider, gear one, gear two, transmission, rotating arm, and turbine blades, according to one embodiment of the current invention.

FIG. 5 is an isometric view of gear one, axle one, gear two, axle two, and the rotating arm, according to one embodiment of the current invention.

### DETAILED DESCRIPTION

As in a typical water-wheel style wind turbine, one embodiment of the current invention is comprised of a first rotational axis and at least one turbine blade. In addition to this simple make-up, however, in the current embodiment, at least one turbine blade is adapted to slide radially through the first rotational axis. The first rotational axis is typically horizontal and perpendicular to the wind direction. However, the first rotational axis can also be vertical.

The radial turbine blade movement generally allows the turbine blade to rotate in a half-circle about the first rotational axis when the wind turbine is viewed from the side. When the turbine blades are rectangularly-shaped and the wind turbine is viewed isometricly, the rotational blade movement combined with the radial movement of the blades generally creates an oval-shaped half-cylinder about the first rotational axis. In alternatives, the turbine blades may create a shape resembling less than a half-circle or half-cylinder. For example, a quarter-cylinder or quarter-circle shape can be created.

Wind force on the turbine blades rotates the blades around the first rotational axis. The half-circle rotational section cut off by the radial sliding is the rotational section where wind force would oppose energy-producing rotational movement. Therefore, by only rotating the turbine blades halfway around the first axis of rotation, the amount of energy lost to wind force opposing energy-producing rotational movement is diminished.

In the usual embodiment, radial blade movement is created through use of a rotating arm and a radial-directing device. The radial-directing device in the typical embodiment is a first rotational axis radially-aligned rotating turbine blade slider, such as a U-shaped track. In alternative embodiments radial blade movement can be created through a system such as, but not limited to, a cable/pulley system adapted to move the blades in a radial manner.

In the typical embodiment, the rotating arm is centered on a second axis of rotation and includes two arm ends which rotate around the second rotational axis. The second rotational axis is generally parallel the first rotational axis. In other variations, the rotating arm can have only one end, or can have more than two ends, such as, but not limited to, “Y”-shaped or “X”-shaped arms.

The arm ends are coupled to turbine blades in a manner allowing the blades to rotate around the arm ends as the arm ends rotate around the second rotational axis. Typically, the rotating arm length is adapted to ensure the arm ends rotate through the first rotational axis. The turbine blades are additionally operatively coupled to the radial-directing slider to ensure radial movement through the first axis of rotation.

Also in the typical rotating arm embodiment, a first gear-first axle combination is centered on the first rotational axis and a second gear-second axle combination is centered on the second rotational axis. The first axle is typically coupled to the turbine blade track. The second axle is typically coupled to the rotating arm. The first and second gears are also typically coupled with a chain. The gear/chain assembly can be replaced by lower-friction assemblies such as, but not limited to, a cable/pulley system.

Embodiments of a typical radial-sliding wind turbine also include a deflection blade and a pivot system. The deflection blade is designed to direct wind onto turbine blades as they slide through the first rotational axis. Since the turbine blades slide radially to decrease opposing wind force, typically using only a half-circle of rotational movement, the deflection blade is typically placed (i) in the first rotational axis half-circle not used by turbine blade rotational movement; and (ii) proximal the first rotational axis. The pivot system is typically a yaw mechanism allowing the wind turbine to rotate in order to substantially face oncoming wind.

One method of generating energy from wind comprises (i) installing a wind turbine in an area which will receive wind, (ii) turning the wind turbine to substantially face the wind, (iii) rotating the turbine blades, and (iv) converting the rotational movement into electrical current. The method uses a wind turbine which includes a first rotational axis and at least one radially-sliding turbine blade, such as described herein.

In the typical method, the first gear-first axle combination rotates at a greater rate than the second gear-second axle combination, thereby causing the rotational arm coupled to the second axle to rotate at a higher rate than the first gear-first axle combination. However, in alternative embodiments and methods, the second axle-rotating arm combination may not rotate at a higher rate than the first gear-first axle combination, and therefore, the rotating radially-aligned slider.

In the typical method, as wind hits a turbine blade, the turbine blade begins to rotate around the rotating arm end it is coupled to. The turbine blade also begins to move radially either towards or away from first rotational axis, depending on its rotational position. In the typical method, the turbine blade slides radially away from the first rotational axis in the rotational section nearest the oncoming wind, and slides radially towards the first rotational axis in the rotational section farthest the oncoming wind. The turbine blade also moves rotationally about the first rotational axis. In the typical embodiment with more than one turbine blade, the blades and rotating arm are designed to ensure that there is adequate clearance between turbine blades as they travel through the first axis of rotation.

Finally, the method is comprised of converting the rotational movement into electrical current through the use of a generator or other similar device.

Terminology The term “radial” or “radially” as used in this specification and the appended claims relates to the center of a circular area, such as, but not limited to, the circular pattern created by turbine blade rotation about an axis of rotation.

The term “radial-directing device” as used in this specification and the appended claims relates to the mechanism used to ensure wind turbine blades move in a radial direction about an axis of rotation. The typical radial-directing device is a U-shaped track adapted to allow turbine blades to slide towards and away from the axis of rotation.

The term “transmission” as used in this specification and the appended claims relates to the connection between the first gear and the second gear.

The term “yaw mechanism” as used in this specification and the appended claims relates to a device used to turn the turbine blades against the wind.

The term “gear ratio” as used in this specification and the appended claims refers to the relationship between the total number of teeth on two individual gears. The ratio is the number of teeth on the gear that power is applied to (the first gear) divided by the number of teeth on the gear the first gear is coupled to (the second gear).

The term “or” as used in this specification and the appended claims is not meant to be exclusive; rather the term is inclusive meaning “either or both”.

References in the specification to “one embodiment”, “an embodiment”, “a preferred embodiment”, “an alternative embodiment”, “embodiments”, “variations”, “a variation” and similar phrases means that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

As applicable, the terms “about” or “generally” as used herein unless otherwise indicated means a margin of +−20%. Also, as applicable, the term “substantially” as used herein unless otherwise indicated means a margin of +−10%. It is to be appreciated that not all uses of the above terms are quantifiable such that the referenced ranges can be applied.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

The term “couple” or “coupled” as used in this specification and the appended claims refers to either an indirect or direct connection between the identified elements, components or objects. Often the manner of the coupling will be related specifically to the manner in which the two coupled elements interact.

First Embodiment of a Wind Turbine Incorporating Radially-sliding Turbine Blades

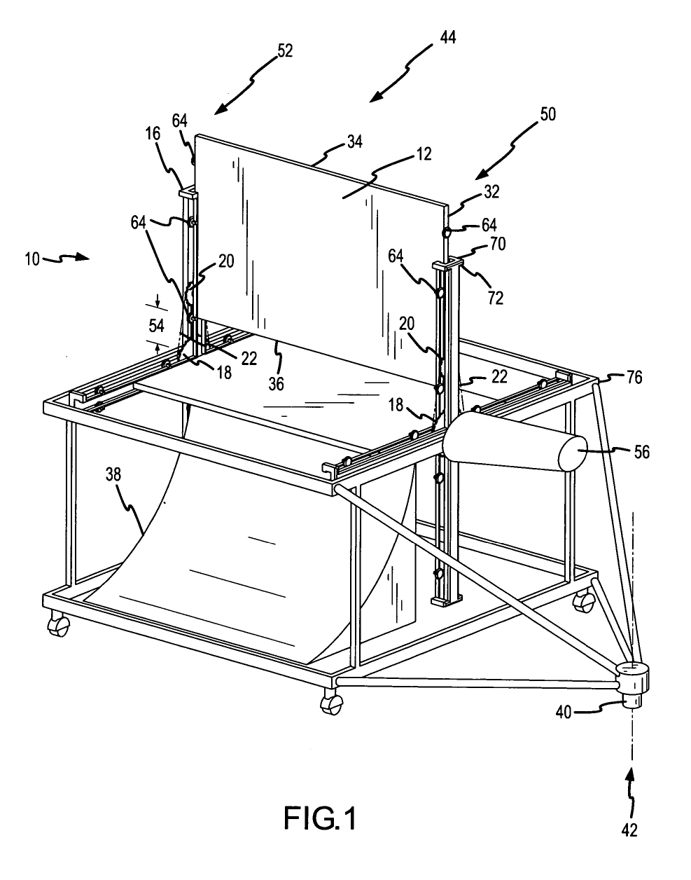

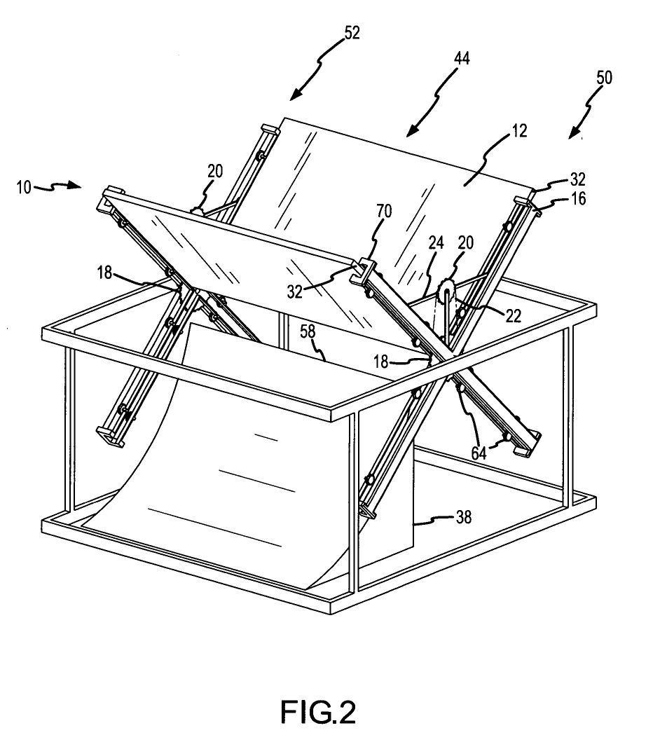

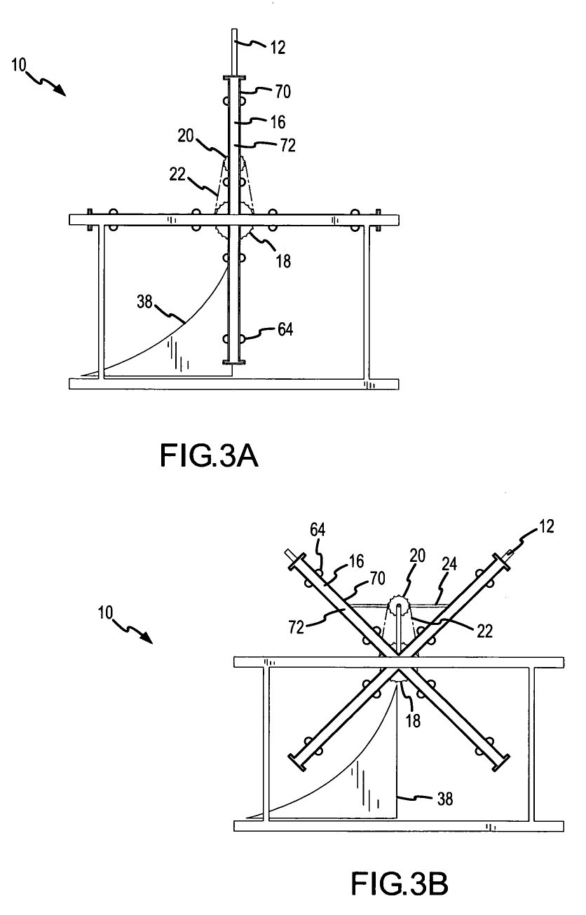

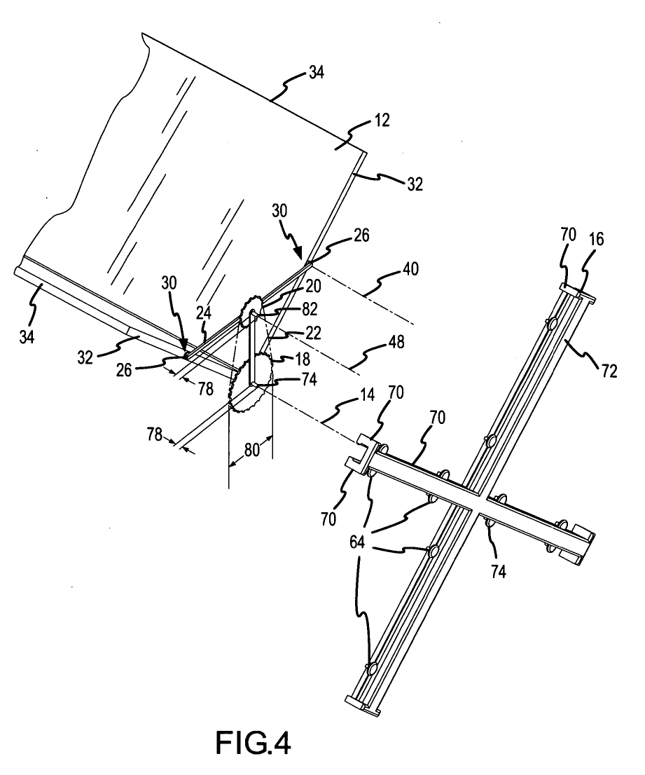

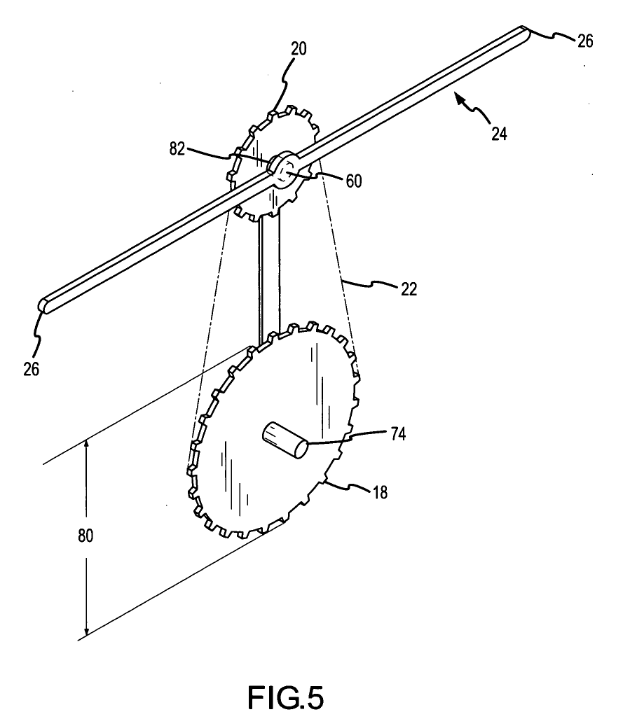

Referring to FIGS. 1 through 5, an embodiment of a wind turbine 10 incorporating at least one radially-sliding turbine blade 12 is illustrated. The turbine blade can be constructed of metal such as aluminum, or the blade can be constructed of another material, such as, but not limited to, a composite material or a fabric material, such as, but not limited to, one that is Teflon coated. The turbine is also comprised of a framework 76 supporting the turbine components.

The typical embodiment 10 also incorporates a first rotational axis 14. The first rotational axis is typically a horizontal axis generally perpendicular to the wind direction. However, the first rotational axis can be vertical. In addition to the first rotational axis and the radially-sliding turbine blades 12, the typical embodiment also incorporates at least one radial-directing device which is typically a U-shaped radial-directing slider 16 that typically dissects and rotates about the first axis of rotation. The radial-directing slider is adapted to allow a turbine blade to slide radially. There is typically a proximal end 50 slider 16 and a distal end 52 slider 16. The typical slider incorporates pair of slider sides 70 flanking a turbine blade edge 32 proximal the slider and a slider side 72 opposing the turbine blade edge 32 proximal the slider.

By dissecting the first axis of rotation 14, the radial-directing sliders 16 are designed to guide the turbine blades 12 towards, through, and away from the first rotational axis 14, depending on the rotational location of the blades. As stated, the typical embodiment 10 has a radial-directing slider located at the proximal end 50 and centered on the first rotational axis. The typical embodiment's distal end 52 slider is also centered about the first rotational axis.

The proximal end 50 and distal end 52 radial-directing sliders 16 can include a slotted and/or a wheeled track, although the typical embodiment includes only a wheeled track. The wheels 64 are typically placed on the track sides 70 flanking the turbine blade. However, in wheeled-track sliders, the turbine blades 12 themselves also typically contain wheels 64. Typically, it is the turbine blade edge 32 which is comprised of the wheels. Alternative radial-directing slider designs are designs such as, but not limited to, cable-pulley systems. Also, alternative radial-directing slider designs may neither be centered nor rotate about the first rotational axis 14.

Each typical radial-directing slider is also coupled to a first axle 74 centered on the first rotational axis 14. The slider/axle coupling typically ensures that the slider is stationary relative to the axle. Mechanisms such as, but not limited to, welds can be used to couple the first axel to the radial-directing slider 16, but in alternatives, less permanent axel/radial-directing slider coupling mechanisms such as, but not limited to, screws or latches can be used. The first axle is also typically rotationally connected to the framework 76.

The proximal end 50 and distal end 52 first axles 74 are typically fixedly coupled to a first toothed gear 18. The length 78 of each axle is typically less than or equal to the diameter 80 of the first gear 18. In alternatives, each first axle may be connected to more than one first gear or the length of the axle can be greater than the diameter of the first gear. Additionally, the first gear can comprise a slotted gear or another type of rotational device such as a pulley. Both the proximal end and distal end first gears are coupled to a second gear 20.

The second gears 20 are operatively coupled to a second rotational axle 82. Each second rotational axle is adapted to freely rotate around a second rotational axis 48. The second rotational axis is generally parallel to the first rotational axis 14. The first and second gears 18 & 20 are typically coupled through the use of a transmission 22. The transmission is typically a chain 22. In variations, a belt or cable can be used along with other suitable means to operatively couple the two gears 18 & 20 (or pulleys).

In the typical embodiment, where the first gear 18 is coupled to the second gear 20 through a chain 22, the second gear/axle combination spins at a higher rate than the first gear/axle combination. Therefore, the first gear is typically bigger than the second gear, with the gear ratio between the two gears being greater than one.

The proximal and distal second rotational axles 82 are also typically coupled to a center portion 60 of a rotating arm 24. The coupling mechanism connecting the second axle and the rotating arm can be, but is not limited to, a weld. The coupling mechanism can also be any other coupling mechanism, such as, but not limited to, a bolted assembly. The center portion of each rotating arm is typically centered on the second rotational axle 82. Therefore, the center portion of the rotating arm is also centered on the second axis of rotation 48.

The typical rotating arm has two arm ends 26. The two ends typically rotate around the second rotational axis 48 and through the first axis of rotation 14. Therefore, in the typical embodiment, the revolutions per minute (rpm's) of the ends are equal to the rpm's of the second rotational axle. In alternatives, the rotating arm can have only one arm end or can have more than two arm ends.

Each rotating arm end 26 is typically rotateably coupled to a turbine blade 12. In the usual embodiment, the arm end and the blade are coupled at a center point 30 of the blade edge 32 proximal the arm end. The blade edge center point is generally the point along the blade edge nearest the rotating arm 24 that is of substantially equal distance between the top end 34 and the bottom end 36 of the blade. For example, for the proximal end 50 and the distal end 52 rotating arms 24, if the turbine blades are rectangular in shape, the blade edge center point is generally the center point on the straight edge proximal the rotating arm. Furthermore, the coupling of the rotating arm end 26 and the turbine blade 12 is adapted to enable the turbine blade to rotate about the rotating arm end.

In the case of circular, oval, or other similarly-shaped turbine blades 12, the blade edge 32 center point 30 is typically the point on the blade edge located closest to the rotating arm 24. In alternative embodiments for either rectangular, circular, oval or any other shaped turbine blades, the placement of the rotating arm and turbine blade coupling can occur at a position other than the blade edge center point.

In the typical embodiment 10, the rotating arm 24 length is less than the distance from the blade top end 34 to the blade bottom end 36, but at least as long as the distance from the first rotational axis 14 to the second rotational axis 48. The blade top end is typically the edge of the blade 12 furthest away from the first axis of rotation when the blade is in the vertical-most position and when the first axis of rotation is horizontal. The blade bottom end is typically the edge of the blade nearest to the first axis of rotation when the blade is in the vertical-most position and when the first axis of rotation is horizontal.

The length of the rotating arm 24 is not just determinative upon the size of the turbine blade 12. The length of the rotating arm also depends upon where the arm end/turbine blade coupling is located on the turbine blade itself. In the typical embodiment where the rotating arm comprises two arm ends 26 and two turbine blades slide radially through the first axis of rotation 14, the rotating arm length must ensure proper clearance 54 between the two turbine blades as one blade exits the first rotational axis 14 and the other blade approaches the first rotational axis. Therefore, as stated, the turbine blade/rotating arm coupling is located in at the blade edge 32 center point 30.

However, if the turbine blade/rotating arm coupling is nearer the blade top end 34 than the blade bottom end 36, the rotating arm will likely need to be longer than the typical rotating arm length. Likewise, for a rotating arm/turbine blade coupling closer to the turbine blade bottom end 36, the rotating arm length will likely need to be shorter than the typical rotating arm length. Alternative rotating arm/turbine blade coupling locations are also dependent upon the number and shape of the turbine blades.

In the typical embodiment 10, the radial-directing sliders 16 previously described combine with the rotating arm 24 to move the turbine blades 12 in a first axis of rotation 14 radial direction. The turbine blades move radially away from the first axis of rotation 14 in the rotational section nearest the oncoming wind and move towards the first axis of rotation in the rotational section farthest the oncoming wind. Briefly stated, each turbine blade begins rotation around the first axis of rotation in a substantially horizontal position. As the wind begins to move a turbine blade from the substantially horizontal position to a substantially vertical position as it rotates around the first axis of rotation, the turbine blade also moves away from the first axis of rotation in a radial direction. Likewise, when the turbine blade begins to move from a substantially vertical position to a substantially horizontal position in relation to the first axis of rotation, the turbine blade also begins to move towards the first axis of rotation in a radial direction.

A typical embodiment 10 can also include a deflection blade 38. Typically, the deflection blade is adapted to direct wind onto a turbine blade 12 as the blade slides through the first rotational axis 14. When the current embodiment is viewed from the side, the deflection blade is typically located within the half-circle of turbine blade rotational movement about the first rotational axis 14 unused by the turbine blades due to the radial movement.

The deflection blade is generally stationary relative to the first rotational axis and at least one deflection blade edge 58 typically generally parallels the first rotational axis and is located proximal the first rotational axis. In alternatives, the embodiment can contain more than one deflection blade which can direct wind onto one or more turbine blades. Additionally, the alternative deflection blades can direct wind onto the turbine blades at locations other than proximal the first rotational axis.

Additionally, a typical embodiment 10 can include a rotational device such as a yaw mechanism 40. The yaw mechanism is adapted to rotate the embodiment to substantially face oncoming wind. A typical yaw mechanism can be comprised of electric motors and gearboxes. However, other rotational devices not including motors or gears can be used. Additionally, a typical yaw mechanism can rotate the wind turbine about an axis of rotation 42. The yaw mechanism can be placed near the proximal end 50. Alternative yaw mechanisms can be placed in or near the center 44 of the embodiment. Other yaw mechanisms can be placed at the distal end 52 of the embodiment or at another location not described herein and may not rotate the turbine 10 about an axis of rotation 42. The goal of the yaw mechanism is to generally limit yaw error.

A typical embodiment 10 will also likely be comprised of a generator 56. The generator is adapted to convert the kinetic energy generated by the wind turning the turbine blades into electrical energy.

One Method of Generating Electrical Energy from Wind Flow

Referring to FIGS. 1 through 5, a method of generating electrical energy from wind flow is illustrated. Initially, a desirable area for wind turbine 10 installation is typically determined. The most desirable wind turbine installation area is typically an area which generates the largest amount of sustained high velocity wind. Other considerations factoring into the decision of where to place the wind turbine can include, but are not limited to, environmental considerations and cost.

Once a suitable area for wind turbine 10 installation is determined, a wind turbine comprising a first rotational axis 14 and at least one radially-sliding turbine blade 12, as described herein, is placed into the area. When the wind turbine is moved into the area, the wind turbine is typically stabilized to diminish the possibility of a substantial mishap occurring from the wind turbine falling or otherwise malfunctioning due to high winds and instability. Stabilization should occur such that the wind turbine blades can easily turn to face the wind. Stabilization can occur through the use of guy-wires. However, alternative stabilization methods can be used.

After stabilization, the wind turbine 10 is typically checked to ensure all turbine parts are in working order so that no turbine malfunction occurs upon initial use. A typical initial-use check can comprise (i) ensuring radial movement of the turbine blades 12; (ii) checking rotational movement of the turbine blades around the first rotational axis 14; and, (iii) ensuring rotational arm 24 and radial-direction slider 16 functionality. However, alternative initial-use checks can be made.

Subsequent to completion of the initial-use check, and upon wind flow occurring, the wind turbine 10 typically turns to substantially face the wind. The wind turbine should substantially face the wind to generally maximize rotational turbine blade 12 velocity, and therefore, electrical output. Typically, the wind turbine rotates to face the wind through the use of a yaw mechanism 40. The yaw mechanism is typically centered about an axis of rotation 42. The yaw mechanism is typically a device comprised of a system of at least one gear adapted to allow the wind turbine to rotate. Alternative yaw mechanisms not employing gears or not centered about an axis of rotation can be used at well.

Upon generally facing the wind, the turbine blades 12 begin to rotate about a first rotational axis 14 upon wind flow onto the turbine blades. The turbine blades rotate about the first rotational axis by being coupled to at least one radial-directing device such as a turbine blade slider 16 which in turn is coupled to a first rotational axle 74. In the current embodiment, the radial-movement slider is typically a radially-aligned U-shaped turbine blade track 16. Radial-aligned U-shaped turbine blade sliders are typically located at the proximal end 50 and the distal end 52 of the current embodiment. The U-shaped slider typically includes one edge 72 opposing the turbine blade edge 32 nearest the slider 16 and two edges 70 flanking the blade edge 32 nearest the slider.

In the current embodiment, the radially-aligned turbine blade sliders 16 are centered on the first rotational axis 14 and coupled to the first rotational axle 74 which is also centered on the first rotational axis 14. The first rotational axle is also rotateably connected to a framework 76. As the wind hits a turbine blade, the force of the wind is applied to the first rotational axle from the turbine blade and the turbine blade slider. The first rotational axle then begins to turn, rotating the turbine blade slider and the coupled turbine blades 12 around the first rotational axis.

The turbine blades' 12 coupling to the turbine blade slider 16 is adapted to allow the turbine blades to radially slide along the U-shaped track. For example, the edges 70 of the turbine blade slider flanking the turbine blade edge 32 can include wheels 64 to help slide the blade along the blade slider. Wheels can also be included on the turbine blade. Alternative turbine blade/turbine blade slider couplings can be a slotted U-shaped blade track instead of a wheeled blade track. The slotted track can also be a shape different than a U-shape. The turbine blade slider coupling to the first rotational axle 74 typically ensures that the turbine blade slider is stationary relative to the first rotational axle. For example, a weld or screw coupling can be employed. However, alternative couplings can be used as well.

During rotational movement, the turbine blades 12 typically slide radially towards, through, and away from the first axis of rotation 14, depending on the turbine blade's rotational location. The radial movement typically ensures that, when viewed from the side, the turbine blades generally complete only one-half of a full rotation about the first rotational axis. In addition to the radial movement towards, through and away from the first axis of rotation 14, there is also typically one point in the turbine blade 12 rotational movement where no radial movement occurs—at the moment between radial movement towards and radial movement away the first rotational axis. This typically occurs when the turbine blade is substantially vertically aligned.

Radial blade movement typically occurs through the use of a rotating arm 24 working in conjunction with the radially-aligned U-shaped turbine blade slider 16. The radial blade movement can also occur through other types of systems, such as, but not limited to, a cable-pulley system. In the rotating arm/turbine blade slider which employs a U-shaped turbine blade track, the center 60 of the rotating arm 24 is typically coupled to a second rotational axle 82 centered at a second axis of rotation 48 generally parallel the first axis of rotation 14. The second rotational axle rotates by being operatively coupled to a second gear 20 which is also generally centered and rotates about the second axis of rotation and is coupled to a first gear 18. The first gear 18 is cooperatively coupled to, and centered on, the first axis of rotation. The coupling mechanisms of each gear to their respective axis can be, but is no limited to, a weld. Other coupling mechanisms ensuring the gears are generally stationary relative to their respective axles may be used as well.

The rotating arm has one or more rotating arm ends 26. The one or more rotating arm ends 26 of the rotating arm 24 are typically rotateably coupled to individual turbine blades 12. The rotating arm/turbine blade coupling is adapted to allow the turbine blade to rotate about the rotating arm end. The length of the rotating arm 24 is typically dependent upon the distance between the first rotational axis 14 and the second rotational axis 48. The rotating arm length is also dependent upon the distance between the turbine blade top end 34 and the turbine blade bottom end 36. Typically, the length of the rotating arm is such that the rotating arm end and the attached turbine blade are typically coupled at the blade edge 32 centerpoint 30. Additionally, the rotating arm end generally travels through the first rotational axis. However, there can be embodiments where the rotating arm end and attached turbine blade do not generally travel through the first axis of rotation.

The second rotational gear 20 is coupled to the first rotational gear 18 through a transmission 22. In the current embodiment, the transmission is a chain. However, alternative systems, such as, but not limited to, cable/pulley or belt-driven systems can be used instead of the gear/chain system. The rotating arm 24 is coupled to the second rotational gear through a second rotational axle 82. As stated, the coupling is adapted to keep the rotating arm stationary relative to the second rotational axle. For example, a weld or screw coupling can be used as the coupling mechanism. However, other coupling mechanisms can be used as well.

As previously explained, the force of the wind on the turbine blades 12 turns the first rotational axle 74. The first axle then rotates the first gear 18, which in turn rotates the turbine blades 12 about the first rotational axis 14 through the use of the turbine blade slider 16. Since the second rotational gear 20 is coupled to the first rotational gear 18 through the transmission 22, the rotation of the first rotational gear rotates the second rotational gear. The first and second rotational gears are designed such that the second rotational gear spins at a rate greater than the first rotational gear. In the typical embodiment, the gear ratio of the first gear to the second gear is greater than one and the second rotational gear spins at a rate twice as fast as the first rotational gear. However, different spin rates can be employed in other embodiments.

As the wind rotates the first rotational gear 18, the second rotational gear 20 spins the rotating arm 24 since the rotating arm is coupled to the second gear through a second axle 82. Since each rotating arm end 26 is rotateably coupled to a turbine blade 12, the turbine blade is forced to move with the rotating arm end. However, as stated, the turbine blade is also coupled to a turbine blade slider 16. Therefore, the turbine blade rotates about the rotating arm end as the rotating arm forces the turbine blade to slide along the blade slider which is rotating at a lesser rate since it is coupled to the first axis of rotation. Additionally, as the blade slider is typically a U-shaped radially-aligned blade track aligned through the first rotational axis, the turbine blades are forced to slide radially through the first rotational axis.

The location of the rotating arm 24 and turbine blade coupling is typically located in the middle of the turbine blade edge 32 proximal the rotating arm. In the typical embodiment employing a proximal end 50 rotating arm and a distal end 52 rotating arm, each rotating arm is coupled to the blade edge proximal the rotating arm. If the turbine blade is comprised of only one edge—circular or otherwise, the coupling is typically situated at a location on the blade edge of generally equal distance between the top end 34 of the turbine blade and the bottom end 36 of the turbine blade when the turbine blade is in the vertical-most position in the standard horizontal rotating axis wind turbine. However, other coupling locations on the proximal turbine blade edge or even not on the proximal turbine blade edge at all, can occur and still allow for radial blade movement.

A typical embodiment is also additionally comprised of a deflection blade 38. The deflection blade is adapted to direct wind onto the turbine blades 12. Typically, when the wind turbine 10 is viewed from the proximal 50 or distal 52 side, the deflection blade is located within the half-circle of rotational movement about the first rotational axis unused by the turbine blades due to the radial movement. Additionally, at least one deflection blade edge 58 is typically located proximal the first axis of rotation 14.

In a typical embodiment 10 where the multiple axes of rotation are horizontal, the wind is directed onto the deflection blade 38 and onto the turbine blade 12 as the turbine blade is traveling radially through the first axis of rotation 14 in a substantially horizontal direction. As the blade begins to rotate around the first axis of rotation, the rotating arm 24 slides the turbine blades away from the first axis of rotation and along the turbine blade slider 16. Upon reaching the first rotational position, which is a substantially vertical blade position, the turbine blade begins to travel towards a substantially horizontal, or second rotational position.

While traveling toward the horizontal position, the rotating arm pulls the turbine blade towards the first axis of rotation along the turbine blade slider, which is typically a U-shaped turbine blade track. Upon reaching the substantially horizontal position while traveling through the first axis of rotation, wind is once again directed onto the turbine blade from the deflection blade and the turbine blade begins to once again slide away from the first axis of rotation and towards a vertical position. This movement ensure the turbine blade completes a one-half rotation around the rotating arm end 24 per one complete rotation about the first rotational axis in the typical embodiment.

In addition to the turbine blade 12 movement described above, the current method also includes converting the kinetic energy contained in the rotational blade movement which turns the first axle 74 into electrical energy. Typically, the energy is converted through the use of a generator 56 generally centered about the first axle. A typical generator induces the flow of an electric current in one or more metal wires through the movement of magnets proximal to the one or more metal wires. However, other types of generators and energy converters can be used.

Lastly, in the current method, the wind turbine 10 is typically maintained. Wind turbine maintenance can include servicing the electrical generator 56. Additional servicing can also include replacing turbine blades 12. Other servicing not described herein can also take place.

Alterative Embodiments and Other Variations:

The embodiments of the radially-sliding wind turbine as illustrated in the accompanying figures and described above are merely exemplary and are not meant to limit the scope of the invention. It is to be appreciated that numerous variations to the invention have been contemplated as would be obvious to one of ordinary skill in the art with the benefit of this disclosure.

Along these lines, in variations, a rotational axis generally parallel to the wind direction can be employed. In such a variation, the radially-sliding blades are designed to generally maximize power output in conjunction with the radial movement. Additionally, a magnetic system for radial movement may be involved in either this system or in the current system where the rotational axis is perpendicular to the wind direction.

Other variations of the current embodiments include a liquid-based device. Such as device could be used in rivers and to capture ocean currents.

Lastly, a variation can include a wind turbine where the turbine blade movement around the first rotational axis is greater than the half-circle half-cylinder described herein. Or, a variation may not include the second rotational axis. In this variation, the rotating arm would be located on the first rotational axis.

I claim:

1) A wind turbine comprising:
a first rotational axis; and
at least one turbine blade adapted to radially slide through the first axis of rotation.

2) The wind turbine of claim 1, further including at least one radial-directing device, the radial-directing device being adapted to guide at least one turbine blade in a general radial direction when sliding.

3) The wind turbine of claim 1, further including a yaw mechanism, the yaw mechanism adapted to rotate the wind turbine to substantially face the wind.

4) The wind turbine of claim 1,
further including a second rotational axis, and
wherein the first and second rotational axes are generally (i) horizontal, and (ii) perpendicular to wind direction.

5) The wind turbine of claim 4, further including at least one rotating arm, the rotating arm comprising a center portion and at least one arm end and being adapted to rotate about the second rotational axis at the center portion.

6) The wind turbine of claim 5 wherein:
the turbine blade includes one or more blade edges, a proximal end, a distal end, a top end, and a bottom end;
the turbine blade being rotateably coupled to the rotating arm end at a blade edge center point; and
the rotating arm length is (i) less than or equal to the length between the turbine blade top end and the turbine blade bottom end, and (ii) at least as great as the distance between the first rotational axis and the second rotational axis.

7) The wind turbine of claim 6, further including:
at least one first rotational axle, the first rotational axle generally centered on the first rotational axis;
at least one second rotational axle, the second rotational axle generally centered on the second rotational axis; and
a transmission, the transmission coupled to the first and second rotational axles.

8) The wind turbine of claim 7, wherein the second rotational axle spins at a higher rate than the first rotational axle.

9) The wind turbine of claim 8, wherein (i) the first rotational axle includes a first gear, (ii) the second rotational axle includes a second gear, (iii) the transmission device is a chain, (iv) the gear ratio is greater than one, and (v) the second axle is coupled to the rotating arm.

10) The wind turbine of claim 1, further including (i) a generator operatively coupled with the first axle, and (ii) at least one deflection blade, the deflection blade being relatively stationary and located generally proximal the first rotational axis.

11) A wind turbine comprising:
at least one rotating arm, the arm including a center portion and at least one end portion, the center portion substantially centered on a second axis of rotation and the end portion orbiting around the second axis of rotation; and
at least one turbine blade, the turbine blade (i) coupled to the end portion of the rotating arm; (ii) adapted to rotate about the end portion of the rotating arm;
and (iii) moving radially through a first axis of rotation.

12) The wind turbine of claim 11, further including a deflection blade, the deflection blade being adapted to direct wind onto the turbine blades.

13) The wind turbine of claim 11, further including at least one turbine blade slider, the turbine blade slider being centered on the first axis of rotation and being adapted to (i) guide at least one turbine blade in a general radial direction when sliding; and (ii) rotate about the first axis of rotation.

14) The wind turbine of claim 11, further including a yaw mechanism, the yaw mechanism adapted to turn the wind turbine to substantially face the wind.

15) A method of generating electrical energy from wind, the method comprising:
installing a wind turbine in an area with wind flow, the wind turbine including (i) a first rotational axis; and (ii) a turbine blade adapted to slide radially through the first axis of rotation;
facing the wind turbine to substantially face the wind;
rotating the turbine blades; and
converting the rotational blade movement energy into electrical energy.

16) The method of claim 15, further including a second rotational axis, and wherein the turbine blade rotational movement is generated by:
wind flowing onto the turbine blade;
the turbine blade moving towards a first rotational position by (i) at least partially rotating about the first and second axes of rotation and (ii) radially sliding away from the first axis of rotation; and
the turbine blade moving towards a second rotational position by (i) at least partially rotating about the first and second axes of rotation and (ii) radially sliding towards the first axis of rotation.

17) The method of claim 16, wherein the first rotational position is a substantially vertical position.

18) The method of claim 15, the wind turbine further including at least one deflection blade and at least one radial-directing device.

19) The method of claim 18, wherein
the blade rotational movement is generated by (i) wind flowing onto the turbine blade, (ii) wind flowing onto the deflection blade, and (iii) the deflection blade wind flow being directed towards the turbine blade;
the turbine blade moves towards a first rotational position by (i) at least partially rotating about the first and second axes of rotation and (ii) radially sliding away from the first axis of rotation; and
the turbine blade moving towards a second rotational position by (i) at least partially rotating about the first and second axes of rotation and (ii) radially sliding towards the first axis of rotation.

20) The method of claim 19, wherein the first rotational position is a vertical position.
